(19) United States
(12) Patent Application Publication
(10) Pub. No.: US 2025/0321809 A1
(43) Pub. Date: Oct. 16, 2025

(54) STRUCTURED AND AUDITABLE RESPONSE GENERATION USING A GENERATED PLAN

(71) Applicant: Scaled Cognition, Inc., Amesbury, MA (US)

(72) Inventors: Adam Pauls, Berkeley, CA (US); Emmanouil Antonios Platanios, Fremont, CA (US); Mitchell Stern, Berkeley, CA (US); Matthew Gardner, Irvine, CA (US); Dan Klein, Berkeley, CA (US); Arya McCarthy, Baltimore, MD (US)

(73) Assignee: Scaled Cognition, Inc., Amesbury, MA (US)

(21) Appl. No.: 18/946,580

(22) Filed: Nov. 13, 2024

Related U.S. Application Data
(60) Provisional application No. 63/632,980, filed on Apr. 11, 2024.

(51) Int. Cl. G06F 9/54

(52) U.S. Cl. CPC G06F 9/542

(57) ABSTRACT

A system that generates an explicit plan to separately guide multiple mechanisms to collectively generate a response to an event. The multiple mechanisms can include a program generation mechanism and a response generation mechanism, each of which may be provided with the generated plan. Each mechanism can utilize a prediction engine, such as for example a machine learning model or large language model, to perform a task based on the generated plan. The event can include an event triggered based on an interaction between an automated agent and a customer. The plan may be generated using a state machine, a machine learning model, such as for example a large language model, or some other mechanism. The plan can be structured such that it can be interpreted and audited for conformance with predefined constraints.

### REFERENCE TO RELATED APPLICATIONS

The present application claims the priority benefit of U.S. provisional patent application 63/632,980, filed on Apr. 11, 2024, titled “Automated Agent Chain-of-Thought Response Generation Using Structure-Based Constraint,” the disclosure of which is incorporated herein by reference.

### BACKGROUND OF THE INVENTION

Computer systems that reason, plan, and communicate with machine learning models often rely on multi-step generation to determine an appropriate action or response. In some cases, a computer system produces a natural language response in response to a customer query. Previous systems utilize no pre-planning or unconstrained pre-planning. These plans are limited in focus and in interpretability. What is needed is an improved system for interacting with a customer.

### SUMMARY OF THE INVENTION

The present technology, roughly described, generates a response to a change of state by an automated agent using structure-based constraints. The system receives input regarding an interaction with a client, external data, and current operations data. The received input is used to generate a plan. The plan can include a plan for how to generate the response. The plan can be constrained, unconstrained, or include both constrained and unconstrained components.

In some instances, the present technology performs a method for structured and auditable response generation using a generated plan. The method begins with generating a plan to process an event detected by an administrative agent implemented on a first server, wherein the administrative agent participates in an interaction with a customer associated with a remote device, and the event is associated with the interaction. The automated agent on the first server can audit the plan to confirm that it conforms to constraints defined by the agent. If the plan does not pass the audit, the automated agent on the first server can produce a new plan given previous inputs as well as an indication of why the first plan failed the audit. The automated agent on the first server can then select and execute one or more programs based on the final generated plan. The automated agent on the first server can then prepare a response to the detected event based on the generated plan. The response is then submitted to the remote device by the automated agent. The programs and responses may be partially, fully, or totally unconstrained to conform to the plan.

In some instances, the present technology includes a non-transitory computer readable storage medium having embodied thereon a program, the program being executable by a processor to structured and auditable response generation using a generated plan. The process begins with generating a plan to process an event detected by an administrative agent implemented on a first server, wherein the administrative agent participates in an interaction with a customer associated with a remote device, and the event is associated with the interaction. The automated agent on the first server can select and execute one or more programs based on the generated plan. The automated agent on the first server can then prepare a response to the detected event based on the generated plan. The response is then submitted to the remote device by the automated agent.

In some instances, the present technology includes a system having one or more servers, each including memory and a processor. One or more modules are stored in the memory and executed by one or more of the processors to generate a plan to process an event detected by an administrative agent implemented on a first server, the administrative agent participating in an interaction with a customer associated with a remote device, the event associated with the interaction, select and execute, by the automated agent on the first server, one or more programs based on the generated plan, prepare, by the automated agent on the first server, a response to the detected event based on the generated plan, and submit the response to the remote device by the automated agent.

### BRIEF DESCRIPTION OF FIGURES

FIG. 1 is a block diagram for providing structured and auditable response generation using a plan.

FIG. 2 is a block diagram of an automated agent application.

FIG. 3 shows data flow for a system that provides structured and auditable response generation using a plan.

FIG. 4 illustrates data flow for a machine learning model.

FIG. 5 illustrates a method for providing structured and auditable response generation using a plan.

FIG. 6 provides a state machine for generating a plan used to generate a response.

FIG. 7 illustrates a method for generating a plan used to generate a response.

FIG. 8 illustrates a method for selecting and executing a program.

FIG. 9 illustrates a method for generating a response based on a plan.

FIG. 10 illustrates an exemplary plan in natural language form.

FIG. 11 illustrates a block diagram of a computing environment.

### DETAILED DESCRIPTION

The present technology generates an explicit plan to separately guide multiple mechanisms to collectively generate a response to an event. The multiple mechanisms can include a program generation mechanism and a response generation mechanism, each of which may be provided with the generated plan. Each mechanism can utilize a prediction engine, such as for example a machine learning model or large language model, to perform a task based on the generated plan. The event can include an event triggered based on an interaction between an automated agent and a customer. For example, the event can include a request made by the customer to the automated agent, such as a request for directions or a request to reserve a hotel room.

The plan may be generated using a state machine, a machine learning model, such as for example a large language model, or some other mechanism. The plan is generated at least in part from conversational context data, which includes a record of an interaction between an automated agent and a customer, as well as functions and results called in order to implement the interaction. The plan can also be generated at least in part from external world state representation data. The external world state representation may include values associated with the interaction between the automated agent and a customer, including but not limited to data retrieved from data stores, reservation number, a destination, and other content.

The plan generated by a plan generator can be constrained. The plan generator can constrain the generated plan in several ways. In some instances, the constraint is implemented using a context free grammar, wherein the plan generator accesses the context free grammar to provide information for generating a program and a response. When the plan is constrained, it allows the plan to be generated more efficiently and quickly than systems that do not constraint outputs.

In some instances, the generated plan can be audited. The generated plan can be audited to determine the correctness or a confidence relating to the program to be generated and the response to be generated. In some instances, the audit can ensure that the plan conforms to plan rules. The plan rules may be stored locally or accessible by the automated agent and may be generated in advance of generating the plan. A plan auditing module performs the auditing to confirm the plan conformity of the plan to the plan rules and, in some instances, can generate a correctness and/or confidence score based on the conversational context, external world-state representation, domain-defined rules, and other input used to generate the plan. In some instances, if the plan does not pass the audit, reasons for the failure can be used to generate a new plan along with the input used to create the first plan. The present application is advantageous over prior systems for several reasons. Previous systems have attempted to generate a response based on conversation data alone. The present technology uses an explicitly generated and structured plan to provide specific steps to a program generation mechanism and a response generation mechanism. As such, each mechanism, for example by use of a language model, can be individually tuned and used to focus on a specific task, rather than relying on a single component to perform multiple tasks. Further, the current system generates a response based on multiple inputs including conversational data, external world state representation, and current operations and results, in addition to the generated plan.

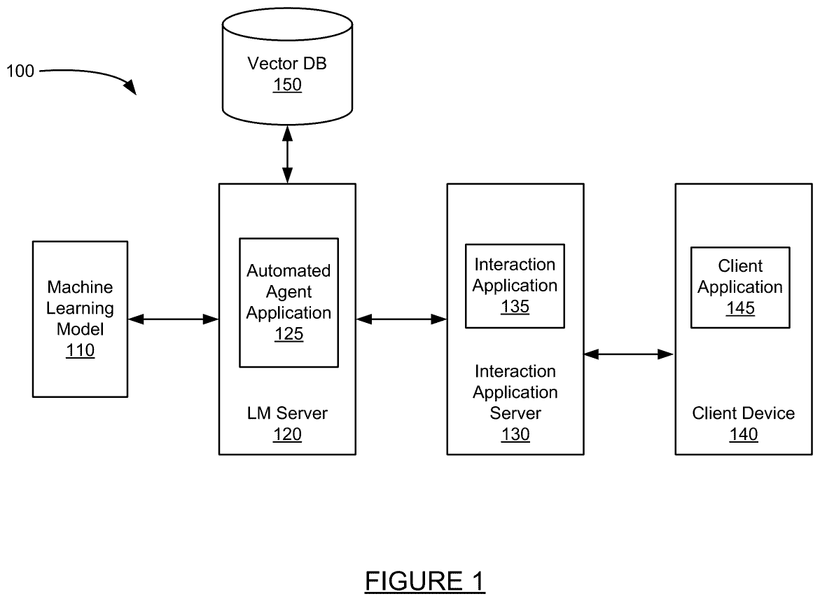

FIG. 1 is a block diagram for providing structured and auditable response generation using a plan. The system 100 of FIG. 1 includes machine learning model 110, language model server 120, interaction application server 130, client device 140, and vector database 150.

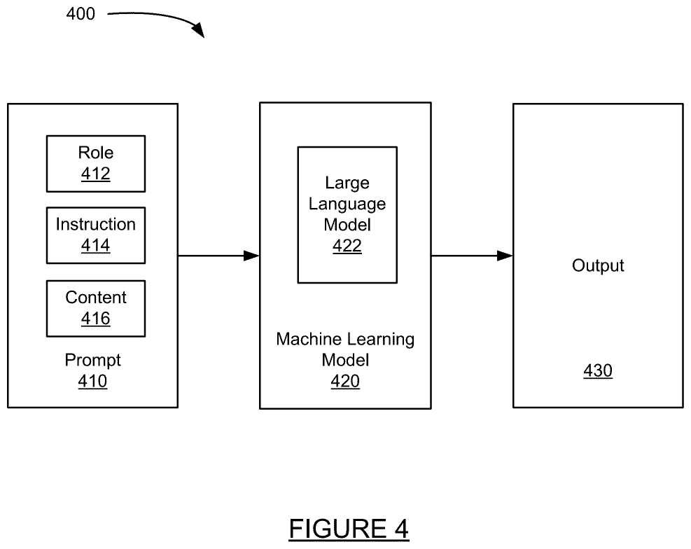

Machine learning model 110 may include one or more models or prediction engines that may receive an input, process the input, and provide an output based on the processing of the input. In some instances, machine learning model 110 may be implemented on LM server 120, on the same physical or logical machine as automated agent application 125. In some instances, machine learning model 110 may be implemented as a large language model, on one or more servers external to LM server 120. Implementing the machine learning model 110 as one or more large language models is discussed in more detail with respect to FIG. 4.

LM server 120 may include an automated agent application 125, and may communicate with machine learning model 110, interaction application server 130, and vector database 150. Automated agent 125 may be implemented on one or more servers 120, may be distributed over multiple servers and platforms, and may be implemented as one or more physical or logical servers.

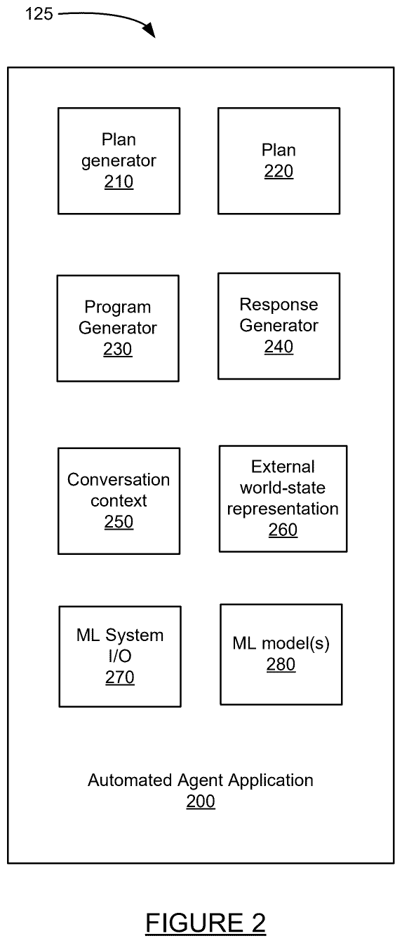

Automated agent application 125 may include one or more modules, mechanisms, or components that may collectively perform the functionality described herein. In some instances, automated agent application 125 may generate a plan, provide the plan to a program generation mechanism and a response generation mechanism, and the plan may be used to generate and execute programs as well as generate a response. More details for automated agent application 125 are provided with respect to FIG. 2.

Interaction application server 130 may communicate with LM server 120, client device 140, and may implement an interaction over a network, such as for example a “chat,” between an automated agent application provided by LM server 120 and client device 140 associated with a customer or client. The interaction may be a chat, text conversation between an automated agent and a client, interaction between a client and a navigation system, or some other interaction.

Vector database 150 may be implemented as a data store that stores vector data. In some instances, vector database 150 may be implemented as more than one data store, internal to the automated agent system provided by LM server 120 and exterior to system 120. In some instances, a vector database can serve as an LLMs' long-term memory and expand an LLMs' knowledge base. Vector database 150 can store private and/or confidential data or domain-specific information outside the LLM as embeddings. In some instances, vector database provides an instruction bank to LM application 125. When a client asks a question to the automated agent system, the system can have the vector database search for the top results, such as for example instructions, most relevant to the received question. Vector database 150 may include data such as prompt templates, instructions, training data, and other data used by LM application 125 and machine learning model 110.

In some instances, the present system may include one or more additional data stores in place of or in addition to vector database 150, at which the system stores searchable data such as instructions, private data, domain-specific data, and other data.

Each of model 110, servers 120-140, and vector database 150 may communicate over one or more networks. The networks may include one or more the Internet, an intranet, a local area network, a wide area network, a wireless network, Wi-Fi network, cellular network, private network, public network. Local area network, or any other network over which data may be communicated.

In some instances, one or more of machines associated with 110, 120, 130, 140, and 150 may be implemented in one or more cloud-based service providers, such as for example AWS by Amazon Inc, AZURE by Microsoft, GCP by Google, Inc., Kubernetes, or some other cloud based service provider.

The system of FIG. 1 illustrates an automated agent application within a chat system formed with ML model 110, LM server 120, interaction application server 130, and client device 140. Illustration of the language model in a chat or automated agent system is for purposes of discussion only, and the language model of the present technology is not intended to be limited to chat systems alone.

FIG. 2 is a block diagram of an automated agent application. The automated agent application 200 of FIG. 2 provides more detail for application 125 in the system of FIG. 1. Automated agent application 200 includes plan generator 210, plan 220, program generator 230, response generator 240, conversation context 250, external world state representation 260, machine learning system input and output 270, and machine learning models 280.

Plan generator 210 may generate a plan for guiding a system to generate a response based on an event detected by the automated agent. The plan generator 210 may be implemented by a state machine, an external or internal machine learning model, or some other content generation mechanism.

Plan generator 210 may generate a plan 220. Plan 220 may provide explicit steps for a program generator to select and execute programs, and explicit steps for a response generator to generate a response. The plan may be expressed in natural language format or in a formatted language, such as Python. Once generated, the plan can be provided to program generator 230 and response generator 240.

Plan 220 may be generated by plan generator 210 based at least in part based on input including conversation context 250 and external world state representation 260. The conversation context may include a log of the interaction between an administrative agent and a client as provided by interaction application 135. In some instances, the record of the interaction may include text exchanged between the two entities. Conversation context may also include programs executed to generate automated agent responses and the results of those programs.

External world state representation may include values of several fields that are relevant to the interaction between the automated agent and a remote customer. For example, external world state representation may include reservation numbers, temperatures, and other data related to the external world.

Program generator 230 may select and execute programs based on an explicit plan. The programs may be selected based on an event detected by an automated agent. For example, if an automated agent detects an event as a customer request for an airline reservation, the program generator 230 may select an airline reservation function and execute that function based on the customer request.

Response generator 240 may generate a response based at least in part on the explict plan. Generator 240 can also generate a response based on conversation context, external world state representation, and the selected programs their results provided by program generator 230. Response generator 240 may propose a response, perform an audit on the response, update the response if necessary, and provide the response to interaction application 135.

Machine learning system I/O 270 may provide a prompt as input to a machine learning model and receive an output from the machine learning model. In some instances, machine learning system input/output 270 may provide inputs to and retrieve outputs from program generator 230 and response generator 240 of the system of FIG. 2.

Machine learning models 280 may include one or more models that can receive input and provide an output. The machine learning models may include one or more machine learning models that generate a plan, select programs for execution, prepare a response, as well as perform other tasks. The machine learning models 280, in some instances, can include one or more LLMs, as well as a combination of LLMs and ML models.

Modules 210-280 illustrated in automated agent application 200 are exemplary, and could be implemented in additional or fewer modules. Automated agent application 200 is intended to at least implement functionality described herein. The design of specific modules, objects, programs, and platforms to implement the functionality is not specific and limited by the modules illustrated in FIG. 2.

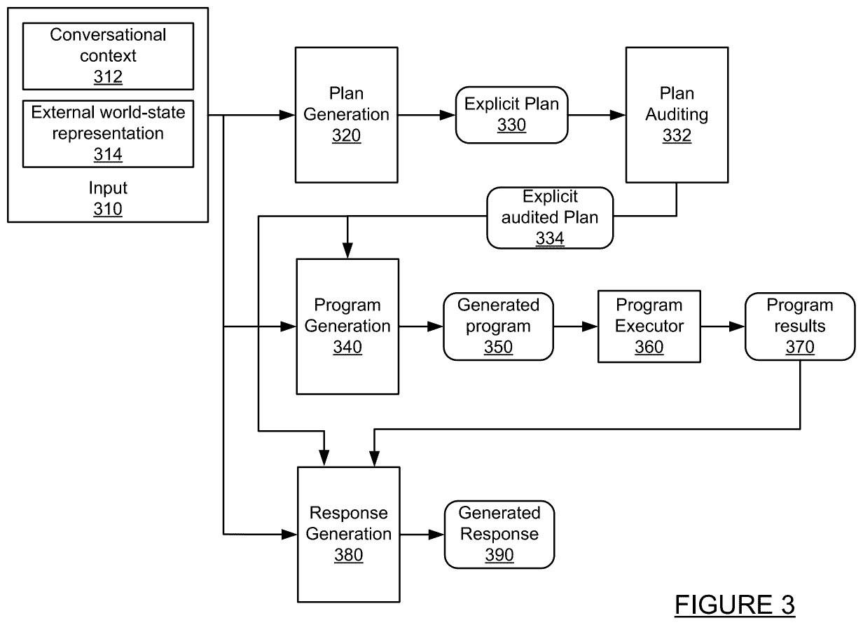

FIG. 3 illustrates data flow for a system that provides structured and auditable response generation using a plan. The data flow illustration of FIG. 3 begins with input 310 provided to plan generation mechanism 320. Input 310 includes conversational context 312 and external world state representation data 315. Plan 330 is generated by the generation mechanism 320. The generation mechanism 320 may utilize a state machine to generate the plan, a large language model or machine learning model, or some other mechanism. Plan 330 generated by plan generation mechanism 320 includes explicit steps to be followed by a program generation mechanism and a response generation mechanism towards providing a response based on an event.

In some instances, the plan is constrained. The plan generator can constrain the generated plan in several ways, for example by using a context free grammar, wherein the plan generator accesses the context free grammar to provide information for generating a program and a response. Providing a constrained plan allows the plan to be generated more efficiently and quickly than systems that do not constraint outputs.

The generated plan 330 can be audited by plan auditing 332. Plan auditing 332 receives and audits the plan to determine the correctness or the confidence in the plan. Plan auditing 332 can re-generate the program generation portion and response generation portion, compare the re-generated portions to the corresponding portions in the original plan, and generate a confidence score based on the comparison. In some instances, the audit can ensure that the plan conforms to plan rules. The plan rules may be stored locally or accessible by the automated agent and may be generated in advance of generating the plan.

In some instances, a plan auditing 332 can generate a confidence score based on the conversational context, external world-state representation, domain-defined rules, and other input used to generate the original plan. Alternatively, the confidence score can be generated by preparing and submitting a prompt to an LLM with the conversational context, external world-state representation, domain-defined rules, and other input, and the LLM will provide a confidence score in the correctness of the plan. Other methods can be used to generate the confidence score as well. If the generated confidence score satisfies a threshold, for example a confidence score above 50, 60, 70, 80, or some other number, the generated and audited plan 334 is provided to the program generator and response generator. If the generated plan does not satisfy the threshold, the a new plan can be generated. The new plan can be generated from information or reasons for the failed audit along with the input used to create the first plan. The new plan is audited and, based on the audit, either forwarded to the program generator and response generator if it satisfies the threshold or modified again.

Program generation 340 receives the plan, as well as input 310, and selects one or more programs 350. The programs are selected to process events, such as customer requests, detected by automated agent application 125. Program generation mechanism 340 generates a program 350 and provides the program to an executor 360. Program executor 360 then executes the selected programs to generate program results 370. The program results 370, and in some instances the generated programs 350, are provided to response generation mechanism 380 along with the plan 330 and input 310.

Response generation mechanism 380 receives the program results 370, plan 330, and input 310, and generates a response. The response may be generated based on one or more state machines, learning models, large language models, or some other mechanism. Once generated, the response may be audited, and the response may be edited or updated based on the audit by response generation mechanism 380. The final response generated by generation mechanism 380 is provided as response 390.

FIG. 4 is a block diagram of data flow for a machine learning model. The block diagram of FIG. 4 includes prompt 410, machine learning model 420, and output 430.

Prompt 410 of FIG. 4 can be provided as input to a machine learning model 420. A prompt can include information or data such as role 412, instructions 414, and content 416. The role indicates the authority level at which the automated agent is to assume while working to assist a user. For example, a role can include an entry-level customer service representative, a manager, a director, or some other customer service job with a particular level of permissions and rules that apply to what they can do and cannot do when assisting a customer.

Instructions 414 can indicate what the machine learning model (e.g., a large language model) is supposed to do with the other content provided in the prompt. For example, the machine learning model instructions may request, via instructions 414, an LLM to determine whether a state machine should execute a function or prepare a response, select one or more functions to be executed, prepare a response, determine if a predicted response was generated with each instruction followed correctly, determine whether or not to transition to a new state within a state machine, determine if a response is correct based on conversation data and functions selected and executed, and so forth. The instructions can be retrieved or accessed from vector database 450, data store 460, a combination of these sources, as well as other sources.

Content 416 may include data and/or information that can assist an ML model or LLM generate an output. For an ML model, the content can include a stream of data that is put in a processable format (for example, normalized) for the ML model to read. For an LLM, the content can include a user inquiry, retrieved instructions, data associated with the present interaction, external world system data, and current operations and data, policy data, checklist and/or checklist item data, programs and functions executed by a state machine, results of an audit or evaluation, and other content. In some instances, where only a portion of the content or a prompt will fit into an LLM input, the content and/or other portions of the prompt can be provided to an LLM can be submitted in multiple prompts.

Machine learning model 420 of FIG. 4 provides more detail for machine learning model 410 of FIG. 4. The ML model 420 may receive one or more inputs and provide an output. In some instances, the ML model may predict an output in the form of whether a policy was followed, whether a particular instruction is relevant, or some other prediction.

ML model 420 may be implemented by a large language model 422. A large language model is a machine learning model that uses deep learning algorithms to process and understand language. LLMs can have an encoder, a decoder, or both, and can encode positioning data to their input. In some instances, LLMs can be based on transformers, which have a neural network architecture, and have multiple layers of neural networks. An LLM can have an attention mechanism that allows them to focus selectively on parts of text. LLMs are trained with large amounts of data and can be used for different purposes.

The transformer model learns context and meaning by tracking relationships in sequential data. LLMs receive text as an input through a prompt and provide a response to one or more instructions. For example, an LLM can receive a prompt as an instruction to analyze data. The prompt can include a context (e.g., a role, such as ‘you are an agent’), a bulleted list of itemized instructions, and content to apply the instructions to.

In some instances, the present technology may use an LLM such as a BERT LLM, Falcon 30B on GitHub, Galactica by Meta, GPT-3 by OpenAI, or other LLM. In some instances, machine learning model 415 may be implemented by one or more other models or neural networks.

Output 430 is provided by machine learning model 420 in response to processing prompt 410 (e.g., an input). For example, when the prompt includes a request that the machine learning model identify the most relevant instructions from a set of content, the output will include a list of the most relevant instructions. In some instances, when the prompt includes a request that the machine learning model determine if an automated agent properly followed a set of instructions, a policy, or a checklist item during a conversation with a user, the machine learning model may return a confidence score, prediction, or other indication as to whether the instructions were followed correctly by the automated agent.

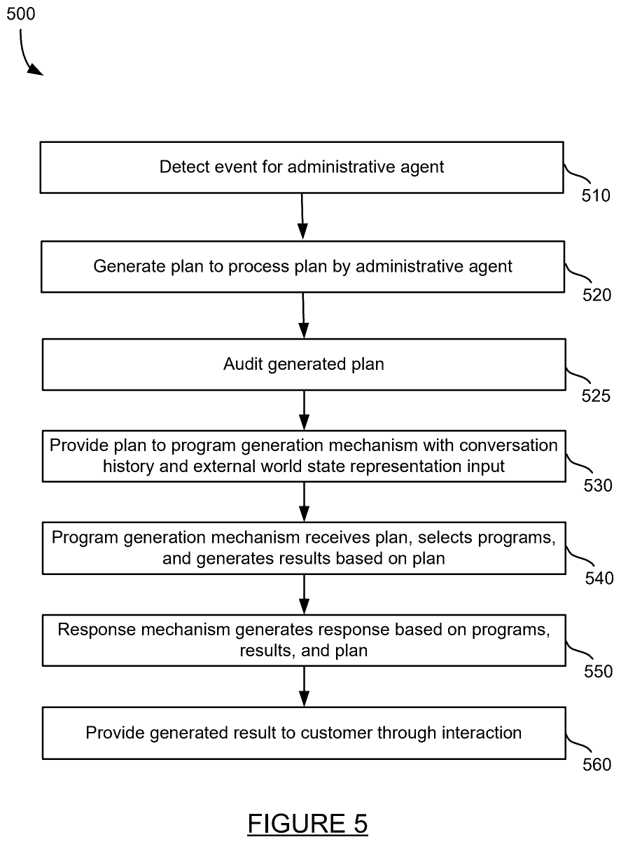

FIG. 5 illustrates a method for providing structured and auditable response generation using a plan. Method 500 of FIG. 5 begins with detecting an event for an automated agent at step 510. The event may be triggered by a request or query received from a customer through an interaction with the automated agent, or can be some other event.

A plan is then generated to process the event by the automated agent at step 520. The plan may include steps for performing actions in response to the event and providing a response to the event. The plan may be generated by a state machine, a machine learning model such as a large language model, or in some other manner.

Generating the plan can include constraining the plan. Aplan generator can constrain the generated plan in several ways. In some instances, the constraint is implemented using a context free grammar, wherein the plan generator accesses the context free grammar to provide information for generating a program and a response. In some instances, other constraints can be used to generate the plan.

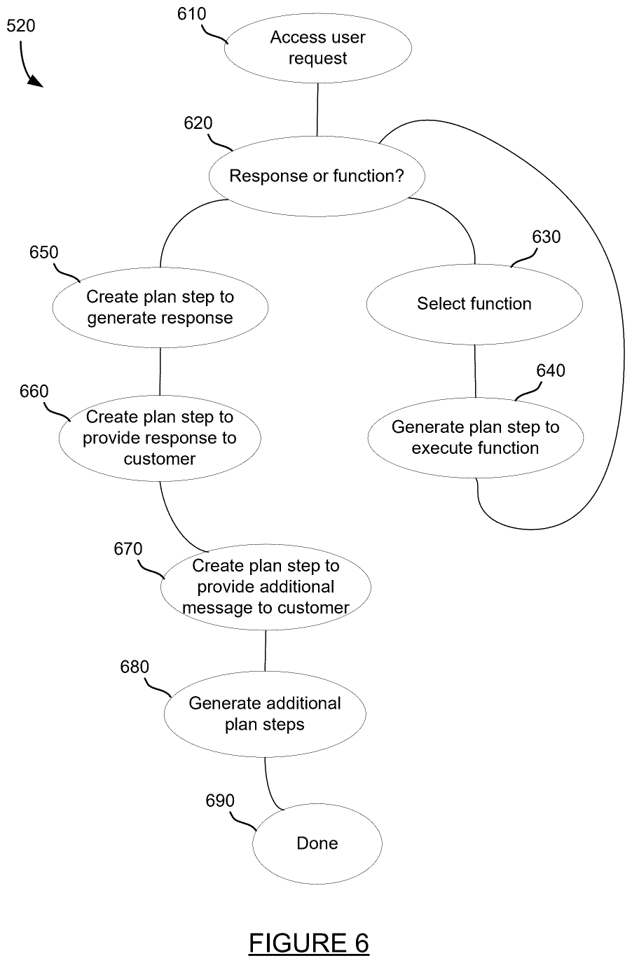

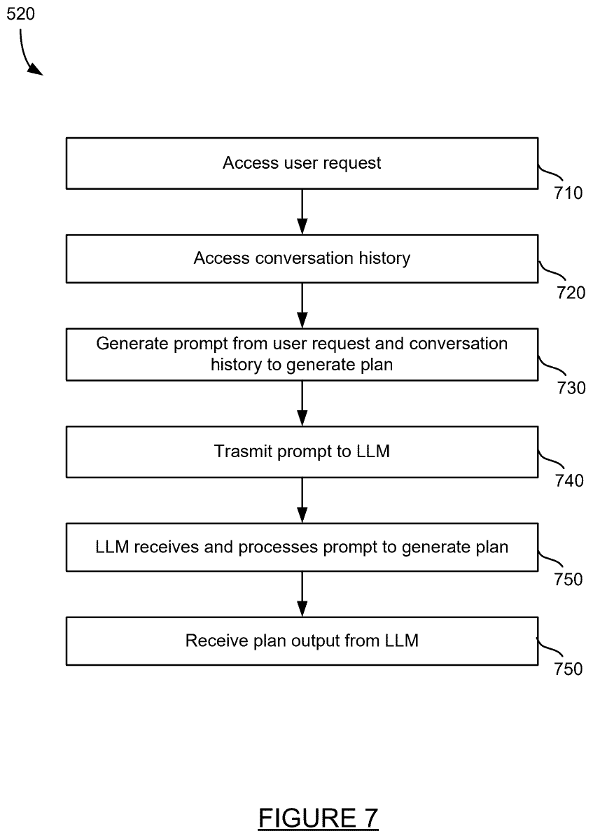

More details for generating a plan using a state machine are discussed with respect to FIG. 6. More details for generating a plan using a large language model are discussed with respect to the method of FIG. 7.

The generated plan can be audited at step 525. A plan auditing 332 module can receive and examine the plan to determine the correctness or the confidence in the plan. In some instances, the audit can ensure that the plan conforms to plan rules. In some instances, auditing the plan includes re-generating the program generation portion and response generation portion of the original plan and comparing these re-generated portions to those in the original plan. A confidence score is then generated based on the conversational context, external world-state representation, and other input used to generate the original plan. If the generated confidence score satisfies a threshold, for example a confidence score above 50, 60, 70, 80, or some other number, the audited plan is determined to satisfy the audit. If the generated plan does not satisfy the threshold, the generated plan is modified with variations of one or more of the conversation context, external world-state representation, and input data. The modified plan is then audited and then, based on the audit, determined to satisfy the threshold and the audit or it is modified again as the auditing process repeats.

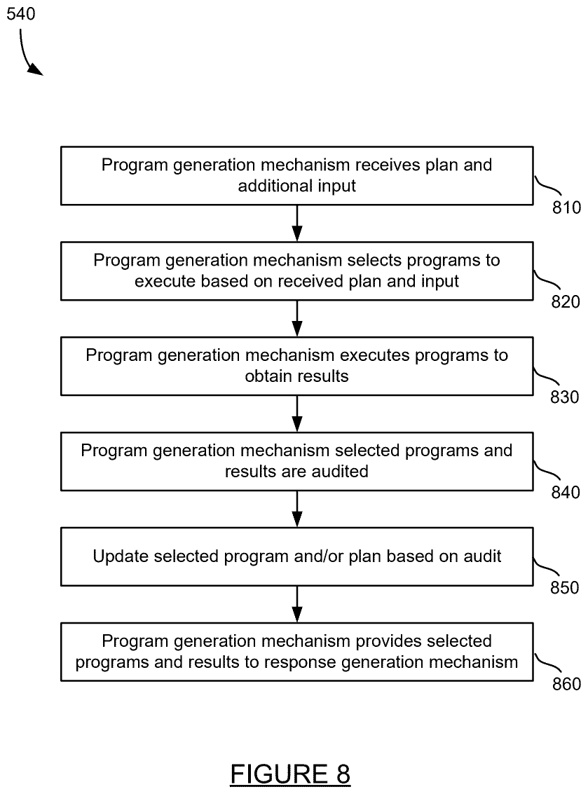

The generated plan is provided to a program generation mechanism at step 530. The plan can be provided with additional input, such as conversation history and external world state representation data. The program generation mechanism receives the plan, selects one or more programs to execute, and executes the programs to generate results at step 540. The programs are selected based on the plan and other data. More detail for selecting programs and generating results by executing the programs based on the received plan is discussed with respect to the method of FIG. 8.

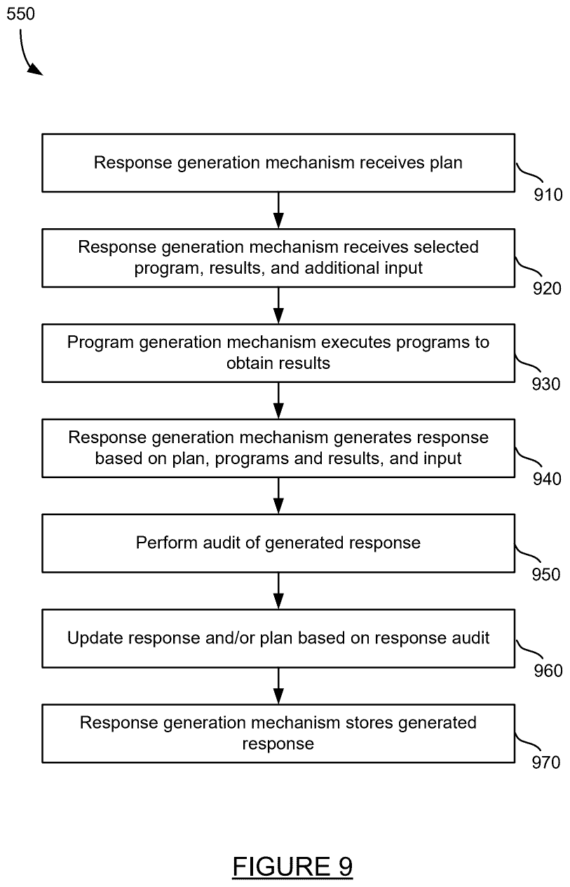

The response mechanism can generate a response based on the results, the executed programs, and other data to at step 550. The response can be generated at least in part from the plan, and the response can be audited before providing the response as output. More detail for generating a response based at least in part on a generated plan is discussed with respect to the method of FIG. 9.

The generated response is then provided to a customer through an interaction at step 560. The response can be provided to the customer by the automated agent through interaction application 135.

FIG. 6 provides a state machine for creating a plan used to generate a response. The state machine 520 of FIG. 6 begins with accessing the user request at state 610. The state machine then transitions to state 620 where it determines whether a response should be generated or a function should be executed. In some instances, conversation history and external world state representation data is provided to a large language model to determine which option should be selected at state 620. If a function is to be selected, the state machine transitions to state 630 to select a function. The plan is then updated with a step to execute the function at step 640. The state machine then transitions back to step 620.

If a response is to be generated at step 620, the plan is modified with steps to generate the response at step 650. The state then transitions to step state 660 to modify the plan with steps to provide a response to the customer. The state machine then transitions to create a step to provide additional messages to a customer, if needed, at state 670. The additional messages may include an invitation to the customer to request any additional requests, or some other message. Any additional plan steps may then be added at state 680, before the state machine ends at state 690.

FIG. 7 illustrates a method for generating a plan used to generate a response. Method 700 of FIG. 7 provides more details of step 520 of the method of FIG. 5. Method 700 begins with accessing a user request at step 710. A conversation context between an automated agent and a customer are then accessed at step 720. A prompt can then be generated from the conversation context to generate the plan at step 730. The generated prompt may be transmitted to a large language machine (LLM) at step 740. The LLM can receive and process the prompt to generate a plan at step 750. The received plan output is received from the LLM by the automated agent at step 750.

FIG. 8 illustrates a method for selecting and executing a program. Method 800 provides more detail for step 540 of the method of FIG. 5. Method 800 begins with receiving the plan and additional input by the program generation mechanism at step 810. The program generation mechanism selects programs to execute based on the received plan and input at step 820. In some instances, the programs may be constrained by the programs available to be executed. The programs are then executed to obtain results at step 830. The programs selected by the program generation mechanism are executed as part of the process to respond to the event detected by the automated agent.

An audit of the selected programs and results are then performed at step 840. In some instances, an audit is performed, for example using a large language model, to determine if the selected programs and results provide a satisfactory answer to a request received from a customer through the interaction between the customer and the automated agent. If it is determined that a different program should be executed, the program, and in some instances the plan, can be updated based on the audit results at step 850. The program generation mechanism then provides the selected programs and results to the response generation mechanism at step 860.

FIG. 9 illustrates a method for generating a response based on a plan. The method of FIG. 9 provides more detail for step 550 of the method of FIG. 5. First, a response generation mechanism receives a plan at step 910. The response generation mechanism receives the selected programs, results, and additional input at step 920. The response is then generated based on the plan, executed programs and results, and additional input at step 930. The response generated by the response generation mechanism is based at least in part on the plan received by the mechanism. An audit of the generated response is performed at step 940. If the audit results in a determination that the response is not acceptable, the response and, in some instances, the plan can be updated based on the response audit at step 950. The response generation mechanism then stores the generated response for transmittal to the customer at step 960.

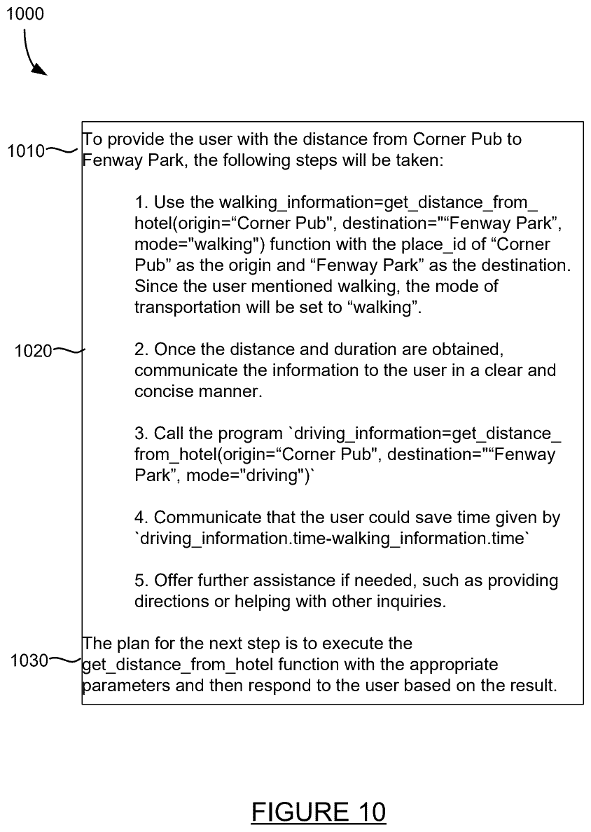

FIG. 10 illustrates an example of a plan generated by a plan generation mechanism. Plan 1000 can include multiple parts, including an opening, a list of steps, and an explicit next step. The opening can indicate the goal of the plan. In plan 1000, the opening 1010 recites that the goal is “to provide the user with the distance from the corner pub to Fenway Park, the following steps will be taken.” The list of steps 1020 in plan 1000 include calling specific programs with specific argument values, how to communicate the results of the function to the customer, and offering additional information to a customer after the requested information is provided. At the end of plan 1000, an indication of the next step 1030 is recited as “the plan for the next step is to execute the get_distance_from_hotel function with the appropriate parameters and then respond to the user based on the results.”

The system can select zero or more programs based on this plan and a response. In some cases, the system can be required to generate programs exactly as they appear in the plan; in other cases, the response generation system may be allowed to deviate.

The plan 1000 of FIG. 10 is expressed in a natural language form. It is understood that the plan could be in different formats, such as a structured language format, XML, or some other format. Additionally, plan 1000 includes three portions, and opening, a list of steps, and an indication of the next step. Additional portions may be implemented within a particular plan in order to select and execute programs in response to a detected event and generate and provide a response to a customer in response to a customer request. Code contained inside a plan can be delimited using special tokens, such as for example at tick mark (′).

The plan of 1000 could be audited against a set of rules. For example, the administrative agent may be required to state the amount of time that could be saved by driving whenever a user requests walking directions. This audit may be implemented by an LLM with an appropriate prompt, or can be accomplished by a simple rule-based system. For example, any plan that calls get_distance_from_hotel with mode=“walking,” but does not also compute the same for mode=“driving,” cannot satisfy this rule and would fail the audit.

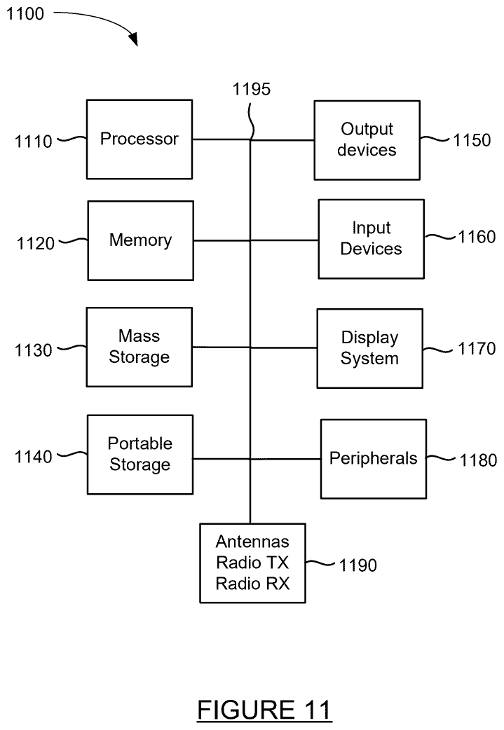

FIG. 11 is a block diagram of a computing environment for implementing the present technology. System 1100 of FIG. 11 may be implemented in the contexts of the likes of machines that implement machine learning model 110, language model server 120, interaction application server 130, client device 140, and vector database 150. The computing system 1100 of FIG. 11 includes one or more processors 1110 and memory 1120. Main memory 1120 stores, in part, instructions and data for execution by processor 1110. Main memory 1120 can store the executable code when in operation. The system 1100 of FIG. 11 further includes a mass storage device 1130, portable storage medium drive(s) 1140, output devices 1150, user input devices 1160, a graphics display 1170, and peripheral devices 1180.

The components shown in FIG. 11 are depicted as being connected via a single bus 1195. However, the components may be connected through one or more data transport means. For example, processor unit 1110 and main memory 1120 may be connected via a local microprocessor bus, and the mass storage device 1130, peripheral device(s) 1180, portable storage device 1140, and display system 1170 may be connected via one or more input/output (I/O) buses.

Mass storage device 1130, which may be implemented with a magnetic disk drive, an optical disk drive, a flash drive, or other device, is a non-volatile storage device for storing data and instructions for use by processor unit 1110. Mass storage device 1130 can store the system software for implementing embodiments of the present invention for purposes of loading that software into main memory 1120.

Portable storage device 1140 operates in conjunction with a portable non-volatile storage medium, such as a floppy disk, compact disk or Digital video disc, USB drive, memory card or stick, or other portable or removable memory, to input and output data and code to and from the computer system 1100 of FIG. 11. The system software for implementing embodiments of the present invention may be stored on such a portable medium and input to the computer system 1100 via the portable storage device 1140.

Input devices 1160 provide a portion of a user interface. Input devices 1160 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, system 1100 as shown in FIG. 11 includes output devices 1150. Examples of suitable output devices include speakers, printers, network interfaces, and monitors.

Display system 1170 may include a liquid crystal display (LCD) or other suitable display device. Display system 1170 receives textual and graphical information and processes the information for output to the display device. Display system 1170 may also receive input as a touch-screen.

Peripherals 1180 may include any type of computer support device to add additional functionality to the computer system. For example, peripheral device(s) 1180 may include a modem or a router, printer, and other device.

The system of 1100 may also include, in some implementations, antennas, radio transmitters and radio receivers 1190. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1100 of FIG. 11 are those typically found in computer systems that may be suitable for use with embodiments of the present invention and are intended to represent a broad category of such computer components that are well known in the art. Thus, computer system 1100 of FIG. 11 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, IOS, ANDROID, as well as languages including Python, PHP, Java, Ruby, .NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for structured and auditable response generation using a generated plan, comprising:
generate a plan to process an event detected by an administrative agent implemented on a first server, the administrative agent participating in an interaction with a customer associated with a remote device, the event associated with the interaction;
select and execute, by the automated agent on the first server, one or more programs based on the generated plan;
prepare, by the automated agent on the first server, a response to the detected event based on the generated plan; and
submit the response to the remote device by the automated agent.

2. The method of claim 1, wherein the generated plan is audited before the one or more programs are executed.

3. The method of claim 1, wherein the plan includes steps for selecting one or more programs.

4. The method of claim 1, wherein the plan includes instructions for providing a response to the event.

5. The method of claim 1, wherein the plan is generated using a state machine.

6. The method of claim 1, wherein the plan is generated by a machine learning model.

7. The method of claim 1, wherein the plan is constrained by a context free grammar.

8. The method of claim 1, wherein the plan is in a natural language format.

9. The method of claim 1, wherein the plan is cin a structured format.

10. The method of claim 1, wherein the one or more programs are selected and executed based on the generated plan, a conversation context between the administrative agent and a customer, and an external world-state representation.

11. The method of claim 1, wherein selecting and executing programs includes:
receiving the plan by a program generation mechanism;
selecting one or more programs to be executed based on the plan by the program generation mechanism; and
executing the selected one or more programs to obtain one or more results; and
auditing the program selection and one or more results based at least in part on the plan by the program generation mechanism.

12. The method of claim 1, wherein preparing the response includes:
receiving the plan by a response generation mechanism;
generating a proposed response based on the plan by the response generation mechanism; and
auditing the proposed response based at least in part on the plan by the response generation mechanism.

13. A non-transitory computer readable storage medium having embodied thereon a program, the program being executable by a processor to structured and auditable response generation using a generated plan, the method comprising:
generate a plan to process an event detected by an administrative agent implemented on a first server, the administrative agent participating in an interaction with a customer associated with a remote device, the event associated with the interaction;
select and execute, by the automated agent on the first server, one or more programs based on the generated plan;
prepare, by the automated agent on the first server, a response to the detected event based on the generated plan; and
submit the response to the remote device by the automated agent.

14. The non-transitory computer readable storage medium of claim 11, wherein the plan includes steps for selecting one or more programs.

15. The non-transitory computer readable storage medium of claim 11, wherein the plan includes instructions for providing a response to the event.

16. The non-transitory computer readable storage medium of claim 11, wherein the plan is generated using a state machine.

17. The non-transitory computer readable storage medium of claim 11, wherein the plan is generated by a machine learning model.

18. The non-transitory computer readable storage medium of claim 11, wherein the plan is in a natural language format.

19. The non-transitory computer readable storage medium of claim 11, wherein the plan is in a structured format.

20. A system for structured and auditable response generation using a generated plan, comprising:
one or more servers, wherein each server includes a memory and a processor; and
one or more mechanisms stored in the memory and executed by at least one of the one or more processors to generate a plan to process an event detected by an administrative agent implemented on a first server, the administrative agent participating in an interaction with a customer associated with a remote device, the event associated with the interaction, select and execute, by the automated agent on the first server, one or more programs based on the generated plan, prepare, by the automated agent on the first server, a response to the detected event based on the generated plan, and submit the response to the remote device by the automated agent.
